(19) United States
(12) Patent Application Publication
(10) Pub. No.: US 2023/0108553 A1
(43) Pub. Date: Apr. 6, 2023

(54) HANDLING A TRANSACTION REQUEST

(71) Applicant: International Business Machines Corporation, Armonk, NY (US)

(72) Inventors: Michael D. Brooks, Southampton (GB); Philip Ivor Wakelin, Eastleigh (GB); Alan Hollingshead, Eastleigh (GB); Julian Charles Horn, Eastleigh (GB)

(21) Appl. No.: 17/494,433

(22) Filed: Oct. 5, 2021

(51) Int. Cl. G06F 9/46; G06F 9/52; G06F 9/50; G06F 16/28

(52) U.S. Cl. CPC G06F 9/466; G06F 9/52; G06F 9/5027; G06F 16/285

(57) ABSTRACT

Embodiments of the present invention provide concepts for handling incoming transaction requests to a transaction server based on a historical record of the server resources required to execute similar transactions in the past and the current capacity of the transaction server. Incoming transaction requests may be classified as heavy weight transactions or light weight transactions and the handling of the transaction requests may be based on said classification.

### BACKGROUND

The technical character of the present invention relates generally to the field of transaction servers, and more particularly, to handling transaction requests at a transaction server.

Transaction servers are typically adapted to receive and process incoming transaction requests from any number of clients in communication with the server. From time to time, such transaction processing servers may encounter server resource constraint issues when a large volume of heavy resource consuming transactions, also referred to as resource intensive transactions or heavy weight transactions, execute concurrently.

In conventional transaction server management schemes, a maximum threshold may be set to limit the number of transactions allowed to execute on the transaction server concurrently. When the maximum threshold is reached, any new transaction requests received at the transaction server are typically queued until the existing transaction requests complete.

There are several drawbacks with such a transaction server management scheme. For example, it is often challenging to select an appropriate maximum threshold, particularly when the maximum threshold is set manually by a user. It is often the case that the selected maximum threshold is a worst-case scenario limit based on a peak workload scenario. Further, any maximum threshold limit that is chosen is often applied universally across the transaction server, which may cause inappropriate limitations to certain aspects of the transaction server.

Further, a serious problem must often occur in the transaction server in order to determine that a transaction caused the server to exceed the maximum threshold. In addition, the nature of a given transaction request may change over time, which may not be considered by the transaction server.

There is therefore a need for an improved mechanism for handling a transaction request.

### SUMMARY

Embodiments of the present invention can provide handling for a transaction request received at a transaction server. Embodiments of the present invention also seek to handle requests for heavy weight transactions, i.e., resource intensive, transactions received at a transaction server. Such embodiments may be computer-implemented. That is, such embodiments may be implemented in a computer infrastructure having computer executable code tangibly embodied on a computer readable storage medium having programming instructions configured to perform a proposed method. Embodiments of the present invention further seeks to provide a computer program product including computer program code for implementing the proposed concepts when executed on a processor. Embodiments of the present invention yet further seeks to provide a system for handling a transaction request received at a transaction server.

According to an aspect of the present invention there is provided a method for handling a transaction request received at a transaction server, wherein the transaction request comprises a request for the transaction server to perform a transaction. The method comprises, responsive to receiving a transaction request at the transaction server, analyzing the transaction request based on a transaction record, which comprises a historical record of a server resource required to perform a transaction, and a current server capacity metric to determine a handling action for handling the transaction request.

Embodiments may be employed in combination with conventional/existing transaction servers. In this way, embodiments may integrate into legacy systems so as to improve and/or extend their functionality and capabilities. An improved transaction server may therefore be provided by proposed embodiments.

According to another embodiment of the present invention, there is provided a computer program product for handling a transaction request by way of a transaction server, wherein the transaction request comprises a request for the transaction server to perform a transaction, the computer program product comprising a computer readable storage medium having program instructions embodied therewith, the program instructions executable by a processing unit to cause the processing unit to perform a method comprising: responsive to receiving a transaction request at the transaction server, analyzing the transaction request based on a transaction record, which comprises a historical record of a server resource required to perform a transaction, and a current server capacity metric to determine a handling action for handling the transaction request.

According to yet another aspect, there is provided a processing system comprising at least one processor and the computer program product according to one or more embodiments, wherein the at least one processor is adapted to execute the computer program code of said computer program product.

According to another aspect, there is provided a system for handling a transaction request by way of a transaction server, wherein the transaction request comprises a request for the transaction server to perform a transaction, the system comprising: a processor arrangement configured to perform the steps of: responsive to receiving a transaction request at the transaction server, analyzing the transaction request based on a transaction record, which comprises a historical record of a server resource required to perform a transaction, and a current server capacity metric to determine a handling action for handling the transaction request.

Thus, there may be proposed concepts for analyzing a transaction request received at a transaction server against a transaction record and a current server capacity metric in order to determine how the transaction request should be handled. For instance, embodiments may provide for a means of dynamically determining how to handle a transaction request based on the resources required to process the transaction request. Providing such a means of determining how to handle an incoming transaction request may help to improve the number of requests that can be handled at a given time and may help to prevent the transaction server from becoming overwhelmed by resource intensive requests.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to embodiments of the present invention.

FIG. 3 depicts abstraction model layers according to embodiments of the present invention.

FIG. 4 depicts a cloud computing node according to another embodiment of the present invention.

FIG. 5 depicts a schematic representation of a method for handling a transaction request at a transactions server according to an embodiment.

FIG. 6 depicts a method of generating a transaction record according to an embodiment.

### DETAILED DESCRIPTION

The figures described above are merely schematic and are not drawn to scale. It should also be understood that the same reference numerals are used throughout the figures to indicate the same or similar parts.

In the context of the present application, where embodiments of the present invention constitute a method, it should be understood a method can be a process for execution by a computer, i.e., can be a computer-implementable method. The various steps of the method therefore can reflect various parts of a computer program, e.g., various parts of one or more algorithms.

Also, in the context of the present application, a (processing) system can be a single device or a collection of distributed devices that are adapted to execute one or more embodiments of the methods of the present invention. For instance, a system can be a personal computer (PC), a server or a collection of PCs and/or servers connected via a network such as a local area network, the Internet and so on to cooperatively execute at least one embodiment of the methods of the present invention.

Also, in the context of the present application, a system can be a single device or a collection of distributed devices that are adapted to execute one or more embodiments of the methods of the present invention. For instance, a system can be a personal computer (PC), a portable computing device (such as a tablet computer, laptop, smartphone, etc.), a set-top box, a server, or a collection of PCs and/or servers connected via a network such as a local area network, the Internet and so on to cooperatively execute at least one embodiment of the methods of the present invention.

The technical character of embodiments of the present invention can generally relate to transaction request management, and more particularly, to handling a transaction request received at a transaction server based on a transaction record and a current server capacity metric. More specifically, embodiments of the present invention can provide concepts for handling a transaction request received at a transaction server, wherein the transaction request can include, but is not limited to, a request for the transaction server to perform a transaction. Responsive to receiving a transaction request at the transaction server, the transaction request can be analyzed based on a transaction record, which can include, but is not limited to, a historical record of a server resource required to perform a transaction, and a current server capacity metric to determine a handling action for handling the transaction request.

Embodiments of the present invention can provide the capability of dynamically determining whether an incoming transaction request should be processed immediately or queued by the server based on a historical record of the server resources required to process the given transaction and the current processing capacity of the server. In this way, the transaction server can dynamically adapt to the incoming transaction requests based on the current server capacity and the processing requirements of the requests.

In an embodiment, the method can include, but is not limited to, monitoring a plurality of transactions processed by the transaction server and generating a transaction record based on the server resource required to process the monitored plurality of transactions. In this way, the transaction server can generate, and update, a transaction record over time according to the individual implementation of the transaction server, thereby improving the relevance of the transaction record.

In a further embodiment, the transaction record can include, but is not limited to, one or more transaction classifications. In this way, the transaction record can include one or more predetermined transaction classifications for comparison to the incoming transaction requests, thereby improving the efficiency of the comparison.

In a further embodiment, generating the transaction record can include, but is not limited to, classifying each of the plurality of transactions according to the one or more transaction classifications, wherein the one or more transaction classifications comprise a heavy weight transaction and a light-weight transaction.

In a further embodiment, a transaction can be classified as a heavy-weight transaction if the server resource required to process the transaction exceeds a resource threshold. In this way, transactions can be classified as a heavy-weight transaction if it is resource intensive. The resource threshold may be set manually by a user.

In an embodiment, a transaction can be classified as a light-weight transaction if the server resource required to process the transaction does not exceed a resource threshold. In this way, transactions can be classified as a light-weight transaction if it is not resource intensive. The resource threshold can be set manually by a user.

In an embodiment, determining the handling action for handling the transaction request can include, but is not limited to, classifying the transaction request based on the analysis of the transaction request and determining the handling action for handling the transaction request based on the classification of the transaction request. In this way, the dynamic adaptation of the transaction server to the incoming transaction requests can be performed according to the classification of the transactions based on the historic record of the server resources required to process the transactions. Thus, the accuracy of the determination to queue or process the transaction request can be improved and tailored to the implementation of the transaction server.

In a further embodiment, determining the handling action for handling the transaction request based on the classification of the transaction request can include, but is not limited to, if the transaction request is classified as a light-weight transaction, wherein a transaction is classified as a light-weight transaction if the server resource required to process the transaction does not exceed a resource threshold, processing the transaction request; and if the transaction request is classified as a heavy-weight transaction, wherein a transaction is classified as a heavy-weight transaction if the server resource required to process the transaction does exceed a resource threshold, queueing the transaction request. In this way, heavy-weight transactions may be queued if the current server capacity is not sufficient to process the request, but light-weight transactions may continue to be processed without interruption.

In a further embodiment, the method further can include, but is not limited to, monitoring the server resource of the transaction server, determining when a heavy-weight transaction can be processed by the transaction server based on the monitored server resource and processing a transaction request, which has been queued, based on the determination. In this way, a queued heavy-weight transaction can be processed when the server possesses the capacity to do so.

In an embodiment, the method further can include, but is not limited to, monitoring the server resource of the transaction server, determining whether a heavy-weight transaction can be processed concurrently with a light-weight transaction by the transaction server based on the monitored server resource and processing the heavy-weight transaction concurrently with a light-weight transaction based on the determination.

In an embodiment, wherein a plurality of transaction requests can be received at the transaction server, the plurality of transaction requests can include, but is not limited to, one or more heavy-weight transactions and one or more light-weight transactions, and wherein the method further can include, but is not limited to, monitoring the server resource of the transaction server, determining whether one or more heavy-weight transactions can be processed concurrently with one or more light-weight transactions by the transaction server based on the monitored server resource, and processing the one or more heavy-weight transactions concurrently with one or more light-weight transactions based on the determination.

In an embodiment, the server resource can include, but is not limited to, one or more memory usage metrics, a peak memory usage metric, a trusted computing base usage metric, a processing time, and a processor usage metric.

In an embodiment, the current server capacity metric can include, but is not limited to, one or more current transactions currently being processed, a memory usage metric, a processor usage metric, and one or more transaction requests in the queue.

In an embodiment, the handling action can include, but is not limited to, one or more queueing the transaction request, processing the transaction request, rejecting the transaction request, verifying the transaction request, and routing the transaction request.

Embodiments of the present invention can further provide concepts for a computer program product for handling a transaction request by way of a transaction server, wherein the transaction request comprises a request for the transaction server to perform a transaction, the computer program product comprising a computer readable storage medium having program instructions embodied therewith, the program instructions executable by a processing unit to cause the processing unit to perform a method can include, but is not limited to, responsive to receiving a transaction request at the transaction server, analyzing the transaction request based on a transaction record, which comprises a historical record of a server resource required to perform a transaction, and a current server capacity metric to determine a handling action for handling the transaction request.

In an embodiment, the computer program product can include, but is not limited to, a computer readable storage medium having program instructions embodied therewith, the program instructions executable by a processing unit to cause the processing unit to, when determining the handling action for handling the transaction request, can perform the steps of classifying the transaction request based on the analysis of the transaction request and determining the handling action for handling the transaction request based on the classification of the transaction request.

Embodiments of the present invention further can provide concepts for a processing system including, but not limited to, at least one processor and the computer program product described above, wherein the at least one processor is adapted to execute the computer program code of said computer program product.

Embodiments of the present invention further can provide concepts for a system for handling a transaction request by way of a transaction server, wherein the transaction request can include, but is not limited to, a request for the transaction server to perform a transaction, the system can include, but is not limited to, a processor arrangement configured to perform the steps of responsive to receiving a transaction request at the transaction server, analyzing the transaction request based on a transaction record, which comprises a historical record of a server resource required to perform a transaction, and a current server capacity metric to determine a handling action for handling the transaction request.

In an embodiment, determining the handling action for handling the transaction request can include, but is not limited to, classifying the transaction request based on the analysis of the transaction request and determining the handling action for handling the transaction request based on the classification of the transaction request.

In an embodiment, determining the handling action for handling the transaction request based on the classification of the transaction request can include, but is not limited to, if the transaction request is classified as a light-weight transaction, wherein a transaction is classified as a light-weight transaction if the server resource required to process the transaction does not exceed a resource threshold, processing the transaction request; and if the transaction request is classified as a heavy-weight transaction, wherein a transaction is classified as a heavy-weight transaction if the server resource required to process the transaction does exceed a resource threshold, queueing the transaction request.

It is understood in advance that although this disclosure includes a detailed description on cloud computing, implementation of the techniques recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

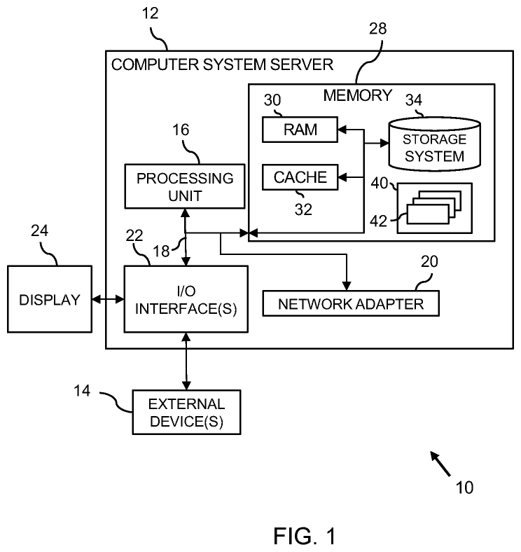

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, etc. to perform tasks or implement abstract data types. Computer system/server 12 may be practiced in distributed cloud computing environments where tasks are performed by remote processing devices that are linked through a communications network. In a distributed cloud computing environment, program modules may reside in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processing unit 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment.

Program modules 42 generally carry out the functions and/or methodologies of embodiments of the invention as described herein. For example, some or all of the functions of a DHCP client can be implemented as one or more of the program modules 42. Additionally, the DHCP client may be implemented as separate dedicated processors or a single or several processors to provide the functionality described herein. In embodiments, the DHCP client performs one or more of the processes described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID (redundant array of inexpensive disks or redundant array of independent disks) systems, tape drives, and data archival storage systems, etc.

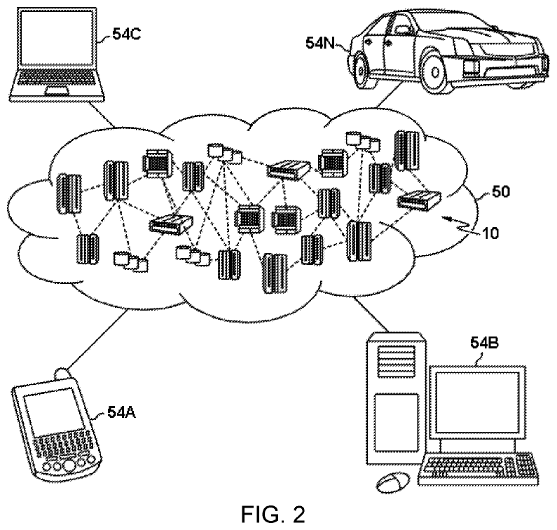

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

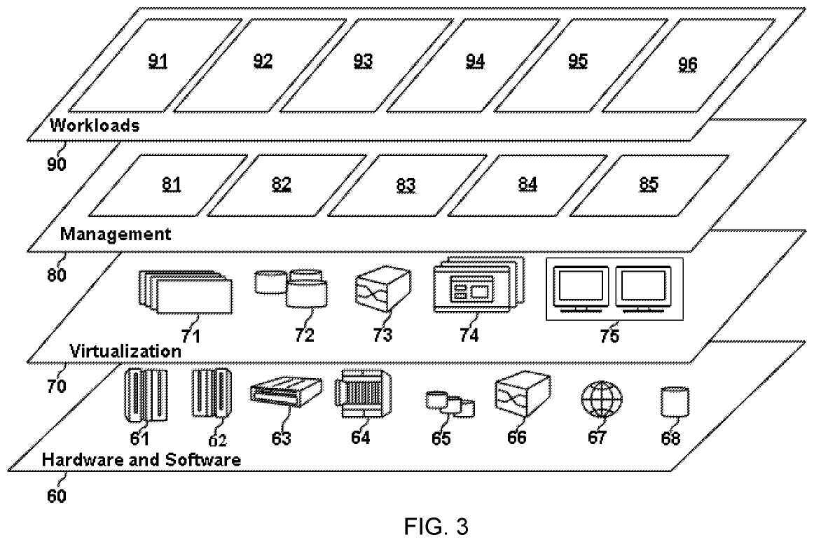

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture-based servers 62; servers 63; blade servers 64; storage device 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workload layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and transaction handling processes 96 described herein. In accordance with aspects of the invention, the transaction handling processes 96 workload/function operates to perform one or more of the processes described herein.

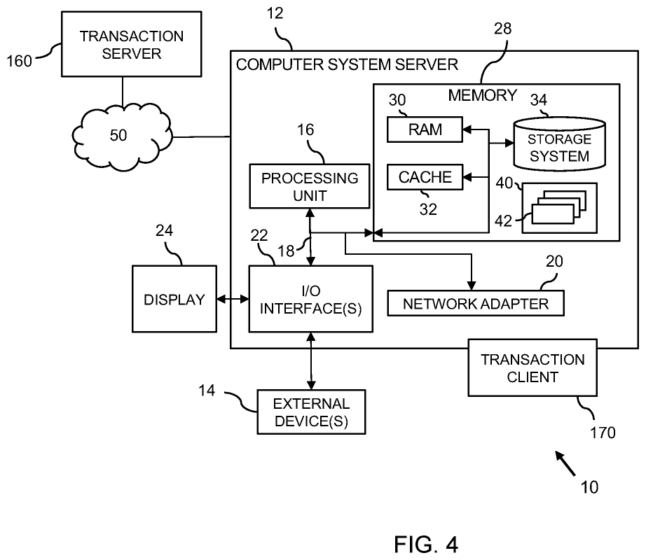

FIG. 4 depicts a cloud computing node according to another embodiment of the present invention. In particular, FIG. 4 is another cloud computing node which comprises a same cloud computing node 10 as FIG. 1. In FIG. 4, the computer system/server 12 also comprises or communicates with a transaction client 170, and a transaction server 160.

In accordance with aspects of the invention, the transaction client 170 can be implemented as one or more program code in program modules 42 stored in memory as separate or combined modules. Additionally, the transaction client 170 can be implemented as separate dedicated processors or a single or several processors to provide the function of these tools. While executing the computer program code, the processing unit 16 can read and/or write data to/from memory, storage system, and/or I/O interface 22. The program code can execute the processes of embodiments of the invention.

By way of example, transaction client 170 can be configured to communicate with the transaction server 160 via a cloud computing environment 50. As discussed with reference to FIG. 2, for example, cloud computing environment 50 can be the Internet, a local area network, a wide area network, and/or a wireless network. In embodiments of the proposed transaction mechanism, the transaction server 160 can provision data to the transaction client 170. One of ordinary skill in the art would understand that the transaction client 170 and transaction server 160 can communicate directly. Alternatively, a relay agent can be used as an intermediary to relay messages between transaction client 170 and transaction server 160 via the cloud computing environment 50.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

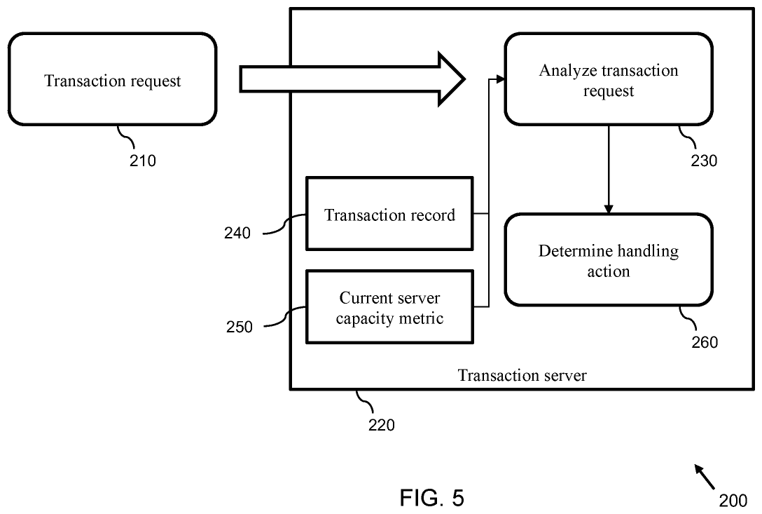

FIG. 5 illustrates an example of handling a transaction request received at a transaction server according to an embodiment. The example embodiment of FIG. 5 can be implemented in the environment of FIGS. 1 and 4, for example. As noted above, the flowchart(s) illustrate the architecture, functionality, and operation of possible implementations of systems, methods, and computer program products as already described herein in accordance with the various embodiments of the present invention. The flowchart and block diagrams in the figures illustrate the architecture, functionality, and operation of possible implementations of systems, methods, and computer program products according to various embodiments of the present invention. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Referring to FIG. 5, there is depicted schematic representation of a computer-implemented method 200 for handling a transaction request 210 received at a transaction server 220. The transaction request comprises a request for the transaction server to perform a transaction. The transaction request may be a request for any type of transaction to be performed, or executed, by way of the transaction server. For example, the transaction request may comprise reading, or writing to, a shared data base. Alternatively, the transaction request may be calling a self-contained program to be run on the transaction server or a program that proceeds to call other programs to perform various functions.

Responsive to receiving the transaction request 210 at the transaction server 220, the transaction request is analyzed 230 based on a transaction record 240 and a current server capacity metric 250. The transaction record comprises a historical record of a server resource required to perform a transaction.

The server resource can include, but is not limited to, one or more memory usage metrics, for example, the proportion of a memory allocation of the server required to process the transaction, a peak memory usage metric, for example, the maximum amount of memory required to process the transaction over the entire processing action; a trusted computing base usage metric, a processing time, i.e., the time taken to process a given transaction, and a processor usage metric, for example, the proportion of a processor allocation of the server required to process the transaction.

Accordingly, the transaction record may be a set of historical records, i.e., one record per transaction ID, wherein each record can represent the typical server resource consumption of a given transaction. Each record can contain entries for critical resource footprints, such as peak virtual storage usage, total CPU usage, duration of transaction, TCB usage and the like. The transaction record can be a rolling average of resource consumption, which is updated as each transaction is executed. Thus, if the behavior of a given transaction type is altered, for example due to functional changes in the client generating the transaction request, these alterations would eventually be reflected in the transaction record.

The current server capacity metric can include, but is not limited to, one or more of a number of current transactions currently being processed; a memory usage metric; a processor usage metric; and a number of transaction requests in the queue. For example, if a large number of transactions are currently being processed at a given time, the current server capacity metric can be reduced, whereas, if a small number of transactions are currently being processed at a given time, the current server capacity metric can be increased. In a further example, if a large proportion of the server memory is currently being used, the current server capacity metric can be reduced, whereas, if a small proportion of the server memory is currently being used, the current server capacity metric can be increased. In a further example, if a large proportion of the processing capacity of the server is currently being used, the current server capacity metric can be reduced, whereas, if a small proportion of the processing capacity of the server is currently being used, the current server capacity metric can be increased. In a further example, if a large number of transactions are currently in the queue, the current server capacity metric can be reduced, whereas, if a small number of transactions are in the queue, the current server capacity metric can be increased.

A handling action can then be determined 260 for handling the transaction request. The handling action can comprise one or more of queueing the transaction request, processing the transaction request, rejecting the transaction request, verifying the transaction request, and routing the transaction request. Examples of handling actions and examples of when a given handling action can be selected for handling a transaction request received at the transaction server are elaborated further below.

Determining the handling action 260 for handling the transaction request 210 can include, but is not limited to, classifying the transaction request based on the analysis of the transaction request and determining the handling action for handling the transaction request based on the classification of the transaction request.

In particular, the transaction request 210 can be classified as a heavy-weight transaction or a light-weight transaction. A transaction request can be classified as a heavy-weight transaction if the server resource required to process the transaction exceeds a resource threshold. A transaction can be classified as a light-weight transaction if the server resource required to process the transaction does not exceed a resource threshold. The transaction record 240 can include, but is not limited to, a historical record of previously executed transactions, which have been classified as a light-weight transaction or a heavy-weight transaction according to the server resource required to process the transactions. An incoming transaction request can then be classified as a heavy-weight transaction or a light-weight transaction if the transaction is determined to match one of the classified transactions in the transaction record.

The transaction record 240 can be generated over time as the transaction server is processing transaction requests. For example, the transaction record can be generated by monitoring a plurality of transactions processed by the transaction server and generating a transaction record based on the server resource required to process the monitored plurality of transactions. In other words, the transaction server can be adapted to monitor transactions as they are executed, and the server resources required to execute said transactions, in order to generate a record of transactions that have been executed by the server and classify those transactions as heavy-weight transactions or light-weight transactions based on the server resources required to execute said transactions.

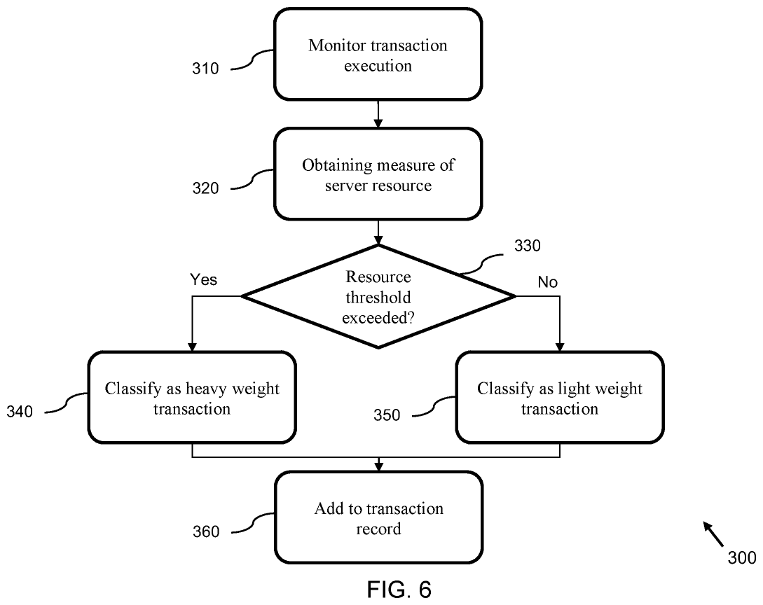

FIG. 6 depicts a computer-implemented method for generating a transaction record 300, which comprises a historical record of a server resource of a transaction server required to perform a transaction.

The method can begin at step 310 by monitoring a transaction being processed, or executed, by the transaction server and obtaining 320 a measure of the server resource required to execute the transaction.

The measure of the server resource required to execute the transaction can then be compared to a resource threshold in step 330. The resource threshold can be any suitable threshold according to the application of the transaction server and the resource threshold can be manually defined by a user.

If the server resource required to execute the transaction exceeds the resource threshold, the transaction can be classified 340 as a heavy-weight transaction and if the server resource required to execute the transaction does not exceed the resource threshold, the transaction can be classified 350 as a light-weight transaction.

In step 360, the classified transaction can then be added to a transaction record.

When an incoming transaction request is received at the transaction server, the incoming transaction request can be compared to the transaction record in order to determine whether the incoming transaction request should be classified as a heavy-weight transaction or a light-weight transaction based on the transactions that have been executed by the transaction server. If the transaction request is classified as a light-weight transaction, wherein a transaction is classified as a light-weight transaction if the server resource required to process the transaction, or the server resource expected to be required to process the transaction, does not exceed a resource threshold as described above, the transaction request can be processed immediately. If the transaction request is classified as a heavy-weight transaction, wherein a transaction is classified as a heavy-weight transaction if the server resource required to process the transaction, or the server resource expected to be required to process the transaction, does exceed a resource threshold, the transaction request can be queued.

It should be noted that a given transaction can be classified differently according to different server resources. For example, a transaction request that requires a large amount of memory to execute but a small amount of processor capacity to execute can be classified as a heavy-weight transaction in relation to memory usage but a light-weight transaction in relation to processor usage. Accordingly, such a transaction can be queued if the current server metric shows low memory availability and high processing capacity, but can be immediately processed in the current server metric shows high memory availability and low processing capacity.

Accordingly, the transaction server can be adapted to categorize different transaction requests based their historical resource usage. The transaction server can automatically place concurrent execution limits on resource heavy, or heavy-weight, transactions while leaving light-weight transactions unaffected. Based on the current system load, the transaction server can decide whether a new heavy weight transaction should be allowed to execute on the server or be queued until the load on the system is reduced, as indicated by the current server capacity metric.

If a transaction request is queued, for example because the transaction was classified as a heavy-weight transaction in relation to a given server resource and current server capacity metric indicates that the heavy-weight transaction cannot be immediately processed, the server resource of the transaction server can be monitored to determine when the heavy-weight transaction can be processed by the transaction server. For example, if the heavy-weight transaction is classified as being resource intensive based on memory usage, the transaction server can monitor the currently available memory and process the transaction when the currently available memory is sufficient for processing the transaction.

The queue of transaction requests can include a maximum queue time, which if exceeded by a given transaction would result in the transaction timing out. In this way, a transaction request can be prevented from occupying the queue indefinitely.

In some cases, when monitoring the server resource of the transaction server, it can be determined that a heavy-weight transaction can be processed concurrently with a light-weight transaction based on the monitored server resource. In this case, the heavy-weight transaction may be processed concurrently with a light-weight transaction. By way of example, a heavy-weight transaction with respect to memory usage can be processed concurrently with a light-weight transaction with respect to processor usage or, if the memory capacity of the server allows, with respect to memory usage.

In practice, the transaction server can receive a plurality of transaction requests from different clients and the plurality of transaction requests can include one or more heavy-weight transactions and one or more light-weight transactions. In this case, the transaction server can analyze the plurality of transaction requests to determine whether the one or more heavy-weight transactions can be processed concurrently with the one or more light-weight transactions. The one or more heavy-weight transactions may then be processed concurrently with the one or more light-weight transactions based on the determination. Further, any number of combinations of heavy-weight transactions and light-weight transactions can be processed concurrently based on the currently available server resources.

The transaction server can be adapted to concurrently process the greatest number of transactions possible. However, to prevent the heavy-weight transactions from being locked out of the processing, the transaction server can be adapted to concurrently process the greatest number of heavy-weight transactions and the remaining resources can be allocated to light-weight transactions.

Further, the transaction server can be adapted to queue light-weight transaction requests to reduce the load on the server when the length of the queue exceeds a predetermined length. By queuing light-weight transactions when the queue becomes a predetermined length, the transaction server can prevent heavy-weight transactions from being frozen out by light-weight transaction requests.

Accordingly, embodiments of the invention provide automated and dynamic transaction request handling on a transaction server based on the classification of the transaction request. In particular, the embodiments can provide handling incoming transaction requests based on a historical record of the server resources required to execute similar transactions in the past and the current capacity of the transaction server.

In other words, the transaction server can make an on-the-fly decision as to whether to run a new transaction request or to defer, or queue, the transaction request based on a combination of historical transaction data and current server capacity.

It should now be understood by those skilled in the art, in embodiments of the present invention, the proposed transaction handling concepts provide numerous advantages over conventional transaction handling approaches. These advantages include, but are not limited to, dynamic and accurate determination of how an incoming transaction request should be handled. In embodiments of the present invention, this technical solution is accomplished based on a historical record of previously handled transactions and a current server capacity metric.

In still further solutions to a technical problem, the systems and processes described herein can provide a computer-implemented method for handling a transaction request received at a transaction server on, or via, a distributed communication network. In this case, a computer infrastructure, such as the computer system shown in FIGS. 1 and 4 or the cloud environment shown in FIG. 2 can be provided and one or more systems for performing the processes of the invention can be obtained (e.g., created, purchased, used, modified, etc.) and deployed to the computer infrastructure. To this extent, the deployment of a system can include, but is not limited to, (i) installing program code on a computing device, such as computer system shown in FIG. 1, from a computer-readable medium; (ii) adding one or more computing devices to the computer infrastructure and more specifically the cloud environment; and (iii) incorporating and/or modifying one or more existing systems of the computer infrastructure to enable the computer infrastructure to perform the processes of the invention.

The descriptions of the various embodiments of the present invention have been presented for purpose of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for handling a transaction request received at a transaction server, wherein the transaction request comprises a request for the transaction server to perform a transaction, the method comprising:
responsive to receiving a transaction request at the transaction server, analyzing the transaction request based on a transaction record, which comprises a historical record of a server resource required to perform a transaction, and a current server capacity metric to determine a handling action for handling the transaction request.

2. The computer-implemented method as claimed in claim 1, wherein the method further comprises:
monitoring a plurality of transactions processed by the transaction server; and
generating a transaction record based on the server resource required to process the plurality of transactions.

3. The computer-implemented method as claimed in claim 2, wherein the transaction record comprises one or more transaction classifications.

4. The computer-implemented method as claimed in claim 3, wherein generating the transaction record comprises classifying each of the plurality of transactions according to the one or more transaction classifications, wherein the one or more transaction classifications comprise:
a heavy weight transaction; and
a light weight transaction.

5. The computer-implemented method as claimed in claim 4, wherein a transaction is classified as a heavy weight transaction if the server resource required to process the transaction exceeds a resource threshold.

6. The computer-implemented method as claimed in claim 4, wherein a transaction is classified as a light weight transaction if the server resource required to process the transaction does not exceed a resource threshold.

7. The computer-implemented method as claimed in claim 3, wherein determining the handling action for handling the transaction request comprises:
classifying the transaction request based on the analyzing of the transaction request; and
determining the handling action for handling the transaction request based on the classification of the transaction request.

8. The computer-implemented method as claimed in claim 7, wherein determining the handling action for handling the transaction request based on the classification of the transaction request comprises:
if the transaction request is classified as a light weight transaction, wherein a transaction is classified as a light weight transaction if the server resource required to process the transaction does not exceed a resource threshold, processing the transaction request; and
if the transaction request is classified as a heavy weight transaction, wherein a transaction is classified as a heavy weight transaction if the server resource required to process the transaction does exceed a resource threshold, queueing the transaction request.

9. The computer-implemented method as claimed in claim 8, wherein the method further comprises:
monitoring the server resource of the transaction server;
determining when a heavy weight transaction can be processed by the transaction server based on the monitoring of the server resource; and
processing a transaction request, which has been queued, based on the determining when a heavy weight transaction can be processed.

10. The computer-implemented method as claimed in claim 8, wherein the method further comprises:
monitoring the server resource of the transaction server;
determining whether a heavy weight transaction can be processed concurrently with a light weight transaction by the transaction server based on the monitoring of the server resource; and
processing the heavy weight transaction concurrently with a light weight transaction based on the determining whether a heavy weight transaction can be processed concurrently with a light weight transaction.

11. The computer-implemented method as claimed in any of claim 8, wherein a plurality of transaction requests are received at the transaction server, the plurality of transaction request comprising one or more heavy weight transactions and one or more light weight transactions, and wherein the method further comprises:
monitoring the server resource of the transaction server;
determining whether one or more heavy weight transactions can be processed concurrently with one or more light weight transaction by the transaction server based on the monitoring of the server resource; and
processing the one or more heavy weight transactions concurrently with one or more light weight transaction based on the determining whether a heavy weight transaction can be processed concurrently with a light weight transaction.

12. The computer-implemented method as claimed in claim 1, wherein the server resource comprise one or more of:
a memory usage metric;
a peak memory usage metric;
a trusted computing base usage metric;
a processing time; and
a processor usage metric.

13. The computer-implemented method as claimed in claim 1, wherein the current server capacity metric comprises one or more of:
a number of current transactions currently being processed;
a memory usage metric;
a processor usage metric; and
a number of transaction requests in a queue.

14. The computer-implemented method as claimed in claim 1, wherein the handling action comprises one or more of:
queueing the transaction request;
processing the transaction request;
rejecting the transaction request;
verifying the transaction request; and
routing the transaction request.

15. A computer program product for handling a transaction request by way of a transaction server, wherein the transaction request comprises a request for the transaction server to perform a transaction, the computer program product comprising a computer readable storage medium having program instructions embodied therewith, the program instructions executable by a processing unit to cause the processing unit to perform a method comprising:
responsive to receiving a transaction request at the transaction server, analyzing the transaction request based on a transaction record, which comprises a historical record of a server resource required to perform a transaction, and a current server capacity metric to determine a handling action for handling the transaction request.

16. The computer program product as claimed in claim 15, the computer program product comprising a computer readable storage medium having program instructions embodied therewith, the program instructions executable by a processing unit to cause the processing unit to, when determining the handling action for handling the transaction request, perform the steps of:
classifying the transaction request based on the analyzing of the transaction request; and
determining the handling action for handling the transaction request based on the classifying of the transaction request.

17. The computer program product as claimed in claim 16, wherein determining the handling action for handling the transaction request based on the classifying of the transaction request comprises:
if the transaction request is classified as a light weight transaction, wherein a transaction is classified as a light weight transaction if the server resource required to process the transaction does not exceed a resource threshold, processing the transaction request; and
if the transaction request is classified as a heavy weight transaction, wherein a transaction is classified as a heavy weight transaction if the server resource required to process the transaction does exceed a resource threshold, queueing the transaction request.

18. A processing system for handling a transaction request by way of a transaction server, wherein the transaction request comprises a request for the transaction server to perform a transaction, the system comprising:
a processor arrangement configured to perform the step of:
responsive to receiving a transaction request at the transaction server, analyzing the transaction request based on a transaction record, which comprises a historical record of a server resource required to perform a transaction, and a current server capacity metric to determine a handling action for handling the transaction request.

19. The processing system as claimed in claim 18, wherein determining the handling action for handling the transaction request comprises:
classifying the transaction request based on the analyzing of the transaction request; and
determining the handling action for handling the transaction request based on the classifying of the transaction request.

20. The processing system as claimed in claim 19, wherein determining the handling action for handling the transaction request based on the classification of the transaction request comprises:
if the transaction request is classified as a light weight transaction, wherein a transaction is classified as a light weight transaction if the server resource required to process the transaction does not exceed a resource threshold, processing the transaction request; and
if the transaction request is classified as a heavy weight transaction, wherein a transaction is classified as a heavy weight transaction if the server resource required to process the transaction does exceed a resource threshold, queueing the transaction request.
